(19) United States
(12) Patent Application Publication
(10) Pub. No.: US 2020/0290624 A1
(43) Pub. Date: Sep. 17, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Takayasu Kumano, Wako-shi (JP)

(21) Appl. No.: 16/809,621

(22) Filed: Mar. 5, 2020

(30) Foreign Application Priority Data
Mar. 13, 2019 (JP) 2019-045692

(51) Int. Cl. B60W 40/06; B60W 30/09; B60W 60/00

(52) U.S. Cl. CPC B60W 40/06; B60W 60/0011; B60W 30/09

(57) ABSTRACT

A vehicle control device includes a recognizer configured to recognize a surrounding environment of a vehicle and a driving controller configured to perform driving control according to speed control and steering control of the vehicle on the basis of a recognition result of the recognizer, wherein the recognizer is configured to recognize a depression on a road where the vehicle travels, and wherein the driving controller is configured to cause the vehicle to travel while riding over the depression in a case where a width of the depression is less than or equal to a predetermined width.

### CROSS-REFERENCE TO RELATED APPLICATION

Priority is claimed on Japanese Patent Application No. 2019-045692, filed Mar. 13, 2019, the content of which is incorporated herein by reference.

### BACKGROUND OF THE INVENTION

### Field of the Invention

The present invention relates to a vehicle control device, a vehicle control method, and a storage medium.

### Description of Related Art

Conventionally, technology relating to a vehicle travel assistance device that controls the traveling of a host vehicle so that a puddle present in a traveling direction of the vehicle is avoided has been disclosed (for example, see Japanese Unexamined Patent Application, First Publication No. 2008-179251).

Incidentally, in the conventional technology, when a puddle is avoided, braking control is performed if there is another vehicle (for example, a following vehicle) around a host vehicle and traveling is performed along a route for avoiding the puddle if there is no other vehicle. However, because some of puddles present on the target trajectory may not be so large, it cannot be said that an appropriate target trajectory is necessarily selected in the conventional technology.

### SUMMARY OF THE INVENTION

The present invention has been made on the basis of the above-described problem recognition and an objective of the present invention is to provide a vehicle control device, a vehicle control method, and a storage medium capable of causing a vehicle to travel along a more suitable target trajectory.

A vehicle control device, a vehicle control method, and a storage medium according to the present invention adopt the following configurations.

(1): According to an aspect of the present invention, there is a provided a vehicle control device including: a recognizer configured to recognize a surrounding environment of a vehicle; and a driving controller configured to perform driving control according to speed control and steering control of the vehicle on the basis of a recognition result of the recognizer, wherein the recognizer is configured to recognize a depression on a road where the vehicle travels, and wherein the driving controller is configured to cause the vehicle to travel while riding over the depression in a case where a width of the depression is less than or equal to a predetermined width.

(2): In the above-described aspect (1), the driving controller is configured to cause the vehicle to travel under a condition that a central portion of the vehicle in a vehicle width direction passes above a central portion of the depression in the vehicle width direction.

(3): In the above-described aspect (1), the recognizer is configured to recognize a deepest portion in the depression, and the driving controller is configured to cause the vehicle to travel under a condition that a central portion of the vehicle in a vehicle width direction passes above the deepest portion.

(4): In the above-described aspect (1), the recognizer is configured to recognize a three-dimensional structure of the depression, and the driving controller is configured to cause the vehicle to travel under a condition that the vehicle is biased toward a side where a rate of change in a height related to the depression in a vehicle width direction is gentle in a case where the driving controller is unable to cause the vehicle to travel under a condition that both wheels of the vehicle are not in contact with the depression.

(5): In the above-described aspect (1), the driving controller is configured to cause the vehicle to travel on a side away from the one end side in a case where the depression has a bias toward one end side of the road in a width direction.

(6): In the above-described aspect (1), the driving controller is configured to cause the vehicle to travel while being biased in a direction in which an area other than an area of the depression is wider in a width direction of the road in a case where the depression is separated from both ends of the road and the vehicle is unable to travel under a condition that both wheels of the vehicle are not in contact with the depression.

(7): In the above-described aspect (6), the driving controller is configured to cause the vehicle to travel on a side away from the adjacent lane in a case where the depression has a bias toward an adjacent lane side and at least a part of a vehicle width of the vehicle is brought into an adjacent lane if the driving controller is configured to cause the vehicle to travel under a condition that both wheels of the vehicle is not in contact with the depression,.

(8): In the above-described aspect (6), the driving controller is configured to cause the vehicle to travel on a side away from the road shoulder in a case where the depression has a bias toward a road shoulder side of the road and at least a part of a vehicle width of the vehicle exceeds a road shoulder if the driving controller is configured to cause the vehicle to travel under a condition that both wheels of the vehicle are not in contact with the depression.

(9): In the above-described aspect (8), the driving controller is configured to cause the vehicle to travel on a side further away from a road shoulder than when the depression has a bias toward an adjacent lane side in a case where the depression has a bias toward the road shoulder side of the road.

(10): In the above-described aspect (5), the driving controller is configured to cause the vehicle to travel at a reduced speed in a case where the depression has a bias toward a road shoulder side of the road.

(11): According to an aspect of the present invention, there is provided a vehicle control method using a computer including: recognizing a surrounding environment of a vehicle; performing driving control according to speed control and steering control of the vehicle on the basis of a recognition result; recognizing a depression on a road where the vehicle travels; and causing the vehicle to travel while riding over the depression in a case where a width of the depression is less than or equal to a predetermined width.

(12): According to an aspect of the present invention, there is provided a computer-readable non-transitory storage medium storing a program for causing a computer of a vehicle control device to: recognize a surrounding environment of a vehicle; perform driving control according to speed control and steering control of the vehicle on the basis of a recognition result; recognize a depression on a road where the vehicle travels; and cause the vehicle to travel while riding over the depression in a case where a width of the depression is less than or equal to a predetermined width.

According to the above-described aspects (1) to (12), it is possible to cause a vehicle to travel along a more suitable target trajectory.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram showing an example of a target trajectory in a depression-passing event according to a first embodiment.

FIG. 4 is a diagram showing a determination criterion of a depression-passing controller according to the first embodiment.

FIG. 5 is a flowchart showing an example of a flow of a process to be executed by the depression-passing controller according to the first embodiment.

FIG. 6 is a diagram showing a first example of a target trajectory of a host vehicle determined by the depression-passing controller according to the first embodiment.

FIG. 7 is a diagram showing a second example of the target trajectory of the host vehicle determined by the depression-passing controller according to the first embodiment.

FIG. 8 is a diagram showing a third example of the target trajectory of the host vehicle determined by the depression-passing controller according to the first embodiment.

FIG. 9 is a diagram showing a determination criterion of a depression-passing controller according to a second embodiment.

FIG. 10 is a flowchart showing an example of a flow of a process to be executed by the depression-passing controller according to the second embodiment

FIG. 11 is a diagram showing a fourth example of a target trajectory of a host vehicle determined by the depression-passing controller according to the second embodiment.

FIG. 12 is a diagram showing a determination criterion of a depression-passing controller according to a third embodiment.

FIG. 13 is a flowchart showing an example of a flow of a process to be executed by the depression-passing controller according to the third embodiment.

FIG. 14 is a diagram showing a fifth example of a target trajectory of a host vehicle determined by the depression-passing controller according to the third embodiment.

FIG. 15 is a diagram showing an example of a hardware configuration of an automated driving control device according to the embodiment.

### DETAILED DESCRIPTION OF THE INVENTION

Embodiments of a vehicle control device, a vehicle control method, and a storage medium of the present invention will be described below with reference to the drawings. Although a case in which left-hand traffic regulations are applied will be described, it is only necessary to reverse the left and right when right-hand traffic regulations are applied.

### First Embodiment

### [Overall Configuration]

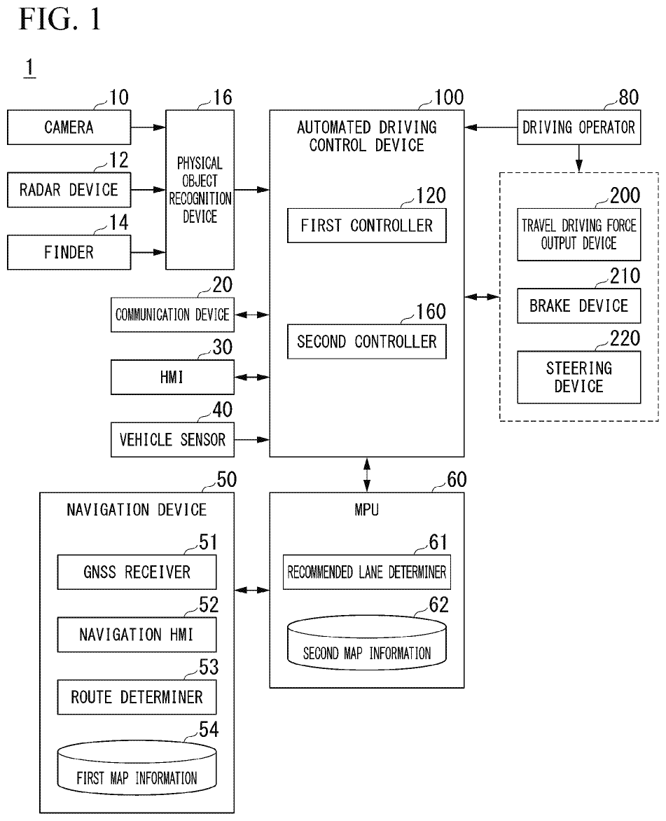

FIG. 1 is a configuration diagram of a vehicle system 1 using a vehicle control device according to an embodiment. A vehicle equipped with the vehicle system 1 is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a power generator connected to the internal combustion engine, or discharge power of a secondary battery or a fuel cell.

For example, the vehicle system 1 includes a camera 10, a radar device 12, a finder 14, a physical object recognition device 16, a communication device 20, a human machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example, a part of the configuration may be omitted, and another configuration may be further added. The automated driving control device 100 is an example of a “vehicle control device”.

For example, the camera 10 is a digital camera using a solid-state imaging element such as a charge coupled device (CCD) or a complementary metal oxide semiconductor (CMOS). The camera 10 is attached to any position on the vehicle (hereinafter, a host vehicle M) on which the vehicle system 1 is mounted. When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object. The radar device 12 is attached to any position on the host vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the host vehicle M and measures scattered light. The finder 14 detects a distance to an object on the basis of time from light emission to light reception. The radiated light is, for example, pulsed laser light. The finder 14 is attached to any position on the host vehicle M.

The physical object recognition device 16 performs a sensor fusion process on detection results from some or all of the camera 10, the radar device 12, and the finder 14 to recognize a position, a type, a speed, and the like of a physical object. The physical object recognition device 16 outputs recognition results to the automated driving control device 100. The physical object recognition device 16 may output detection results of the camera 10, the radar device 12, and the finder 14 to the automated driving control device 100 as they are. The physical object recognition device 16 may be omitted from the vehicle system 1.

The communication device 20 communicates with another vehicle present in the vicinity of the host vehicle M or communicates with various types of servers via a wireless base station using, for example, a cellular network or a Wi-Fi network, Bluetooth (registered trademark), dedicated short range communication (DSRC), or the like.

The HMI 30 presents various types of information to an occupant of the host vehicle M and receives an input operation of the occupant. The HMI 30 includes various types of display devices, a speaker, a buzzer, a touch panel, a switch, keys, and the like.

The vehicle sensor 40 includes a vehicle speed sensor configured to detect the speed of the host vehicle M, an acceleration sensor configured to detect acceleration, a yaw rate sensor configured to detect an angular speed around a vertical axis, a direction sensor configured to detect a direction of the host vehicle M, and the like.

For example, the navigation device 50 includes a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by a link. The first map information 54 may include a curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

For example, the MPU 60 includes a recommended lane determiner 61 and stores second map information 62 in a storage device such as an HDD or a flash memory. The recommended lane determiner 61 divides the route on the map provided from the navigation device 50 into a plurality of blocks (for example, divides the route every 100 [m] with respect to a traveling direction of the vehicle), and determines a recommended lane for each block with reference to the second map information 62. The recommended lane determiner 61 determines what number lane the vehicle travels in from the left. The recommended lane determiner 61 determines the recommended lane so that the host vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/zip code), facility information, telephone number information, and the like. The second map information 62 may be updated at any time when the communication device 20 communicates with another device.

For example, the driving operator 80 includes an accelerator pedal, a brake pedal, a shift lever, a steering wheel, a steering wheel variant, a joystick, and other operation elements. A sensor configured to detect an amount of operation or the presence or absence of an operation is attached to the driving operator 80, and a detection result thereof is output to the automated driving control device 100 or some or all of the travel driving force output device 200, the brake device 210, and the steering device 220.

The automated driving control device 100 includes, for example, a first controller 120 and a second controller 160. The first controller 120 and the second controller 160 are implemented, for example, by a hardware processor such as a central processing unit (CPU) executing a program (software). Some or all of these components are implemented, for example, by hardware (a circuit including circuitry) such as large scale integration (LSI), an application specific integrated circuit (ASIC), a field-programmable gate array (FPGA), or a graphics processing unit (GPU) or may be implemented by cooperation between software and hardware. The program may be pre-stored in a storage device such as an HDD or a flash memory of the automated driving control device 100 (a storage device including a non-transitory storage medium) or may be installed in the HDD or the flash memory of the automated driving control device 100 when the program is stored in a removable storage medium such as a DVD or a CD-ROM and the storage medium (the non-transitory storage medium) is mounted in a drive device.

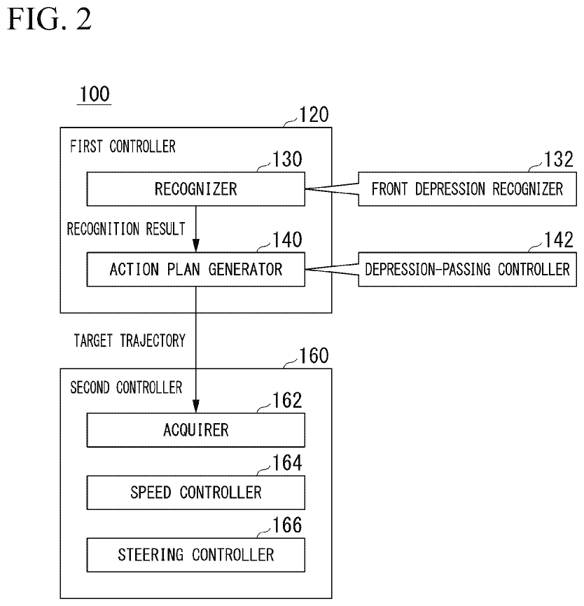

FIG. 2 is a functional configuration diagram of the first controller 120 and the second controller 160. The first controller 120 includes, for example, a recognizer 130 and an action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions. Thereby, the reliability of automated driving is secured. A combination of the action plan generator 140 and the second controller 160 is an example of a “driving controller”.

The recognizer 130 recognizes a state such as a position, velocity, or acceleration of a physical object present in the vicinity of the host vehicle M on the basis of information input from the camera 10, the radar device 12, and the finder 14 via the physical object recognition device 16. For example, the position of the physical object is recognized as a position on absolute coordinates with a representative point (a center of gravity, a driving shaft center, or the like) of the host vehicle M as the origin and is used for control. The position of the physical object may be represented by a representative point such as a center of gravity or a corner of the physical object or may be represented by a represented region. The “state” of a physical object may include acceleration or jerk of the physical object or an “action state” (for example, whether or not a lane change is being made or intended).

For example, the recognizer 130 recognizes a lane in which the host vehicle M is traveling (a travel lane). For example, the recognizer 130 recognizes the travel lane by comparing a pattern of a road dividing line (for example, an arrangement of solid lines and broken lines) obtained from the second map information 62 with a pattern of road dividing lines in the vicinity of the host vehicle M recognized from an image captured by the camera 10. The recognizer 130 may recognize a travel lane by recognizing a traveling path boundary (a road boundary) including a road dividing line, a road shoulder, a curb stone, a median strip, a guardrail, or the like as well as a road dividing line. In this recognition, a position of the host vehicle M acquired from the navigation device 50 or a processing result of the INS may be added. The recognizer 130 recognizes a temporary stop line, an obstacle, red traffic light, a toll gate, and other road events.

When the travel lane is recognized, the recognizer 130 recognizes a position or orientation of the host vehicle M with respect to the travel lane. For example, the recognizer 130 may recognize a gap of a reference point of the host vehicle M from the center of the lane and an angle formed with respect to a line connecting the center of the lane in the travel direction of the host vehicle M as a relative position and orientation of the host vehicle M related to the travel lane. Alternatively, the recognizer 130 may recognize a position of the reference point of the host vehicle M related to one side end portion (a road dividing line or a road boundary) of the travel lane or the like as a relative position of the host vehicle M related to the travel lane. The recognizer 130 includes a front depression recognizer 132. The front depression recognizer 132 will be described below.

The action plan generator 140 generates a future target trajectory along which the host vehicle M automatedly travels so that the host vehicle M can generally travel in the recommended lane determined by the recommended lane determiner 61 and further cope with a surrounding situation of the host vehicle M. For example, the target trajectory includes a speed element. For example, the target trajectory is represented by sequentially arranging points (trajectory points) at which the host vehicle M is required to arrive. The trajectory point is a point where the host vehicle M is required to reach for each predetermined traveling distance (for example, about several meters [m]) along a road. In addition, a target speed and target acceleration for each predetermined sampling time (for example, about several tenths of a second [sec]) are generated as parts of the target trajectory. The trajectory point may be a position at which the host vehicle M is required to arrive at the sampling time for each predetermined sampling time. In this case, information about the target speed or the target acceleration is represented by an interval between the trajectory points.

The action plan generator 140 may set an automated driving event when the target trajectory is generated. The automated driving event includes a constant-speed traveling event, a low-speed following event, a lane change event, a branching event, a merging event, a takeover event, a depression-passing event, and the like. The action plan generator 140 generates a target trajectory according to the activated event. The action plan generator 140 includes a depression-passing controller 142. The depression-passing controller 142 will be described below.

The second controller 160 controls the travel driving force output device 200, the brake device 210, and the steering device 220 so that the host vehicle M passes through the target trajectory generated by the action plan generator 140 at a scheduled time.

Returning to FIG. 2, the second controller 160 includes, for example, an acquirer 162, a speed controller 164, and a steering controller 166. The acquirer 162 acquires information of a target trajectory (a trajectory point) generated by the action plan generator 140 and causes the acquired information to be stored in a memory (not shown). The speed controller 164 controls the travel driving force output device 200 or the brake device 210 on the basis of speed elements associated with the target trajectory stored in the memory. The steering controller 166 controls the steering device 220 in accordance with a degree of curve of a target trajectory stored in the memory. For example, processes of the speed controller 164 and the steering controller 166 are implemented by a combination of feed-forward control and feedback control. As one example, the steering controller 166 executes feed-forward control according to the curvature of the road in front of the host vehicle M and feedback control based on a deviation from the target trajectory in combination.

The travel driving force output device 200 outputs a travel driving force (torque) for driving the vehicle to the drive wheels. The travel driving force output device 200 includes, for example, a combination of an internal combustion engine, an electric motor, a transmission, and the like, and an electronic control unit (ECU) that controls these components. The ECU controls the above-described components in accordance with information input from the second controller 160 or information input from the driving operator 80.

For example, the brake device 210 includes a brake caliper, a cylinder configured to transfer hydraulic pressure to the brake caliper, an electric motor configured to generate hydraulic pressure in the cylinder, and a brake ECU. The brake

ECU controls the electric motor in accordance with the information input from the second controller 160 or the information input from the driving operator 80 so that brake torque according to a braking operation is output to each wheel. The brake device 210 may include a mechanism configured to transfer the hydraulic pressure generated by an operation of the brake pedal included in the driving operator 80 to the cylinder via a master cylinder as a backup. Also, the brake device 210 is not limited to the above-described configuration and may be an electronically controlled hydraulic brake device configured to control the actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor to change the direction of the steerable wheels in accordance with the information input from the second controller 160 or the information input from the driving operator 80.

### [Depression-Passing Event]

Hereinafter, a depression-passing event based on the front depression recognizer 132 and the depression-passing controller 142 will be described. The following description is based on the assumption that a process is performed on the basis of a real space viewed from above. The front depression recognizer 132 recognizes a depression present on a road where the host vehicle M travels. The depression-passing controller 142 generates a target trajectory along which the host vehicle M travels in an area of a road where a depression is present. Then, in the automated driving control device 100, the second controller 160 controls the traveling of the host vehicle M. In the following description, a puddle in which rainwater or the like accumulates within the depression will be described as an example of the depression.

For example, the front depression recognizer 132 can recognize the puddle (the depression) on the basis of information of reflectance and brightness of light of a physical object recognized by the physical object recognition device 16 from an image captured by the camera 10. For example, the front depression recognizer 132 may recognize the puddle (the depression) on the basis of information of reflectance of light emitted by the finder 14.

The depression-passing controller 142 generates a target trajectory including a trajectory that rides over the puddle in accordance with a size of the puddle as described below. The fact that “the host vehicle M rides over the puddle” means that at least a part of an area of a vehicle body between the two wheels mounted on the host vehicle M in a vehicle width direction passes above an area occupied by the puddle.

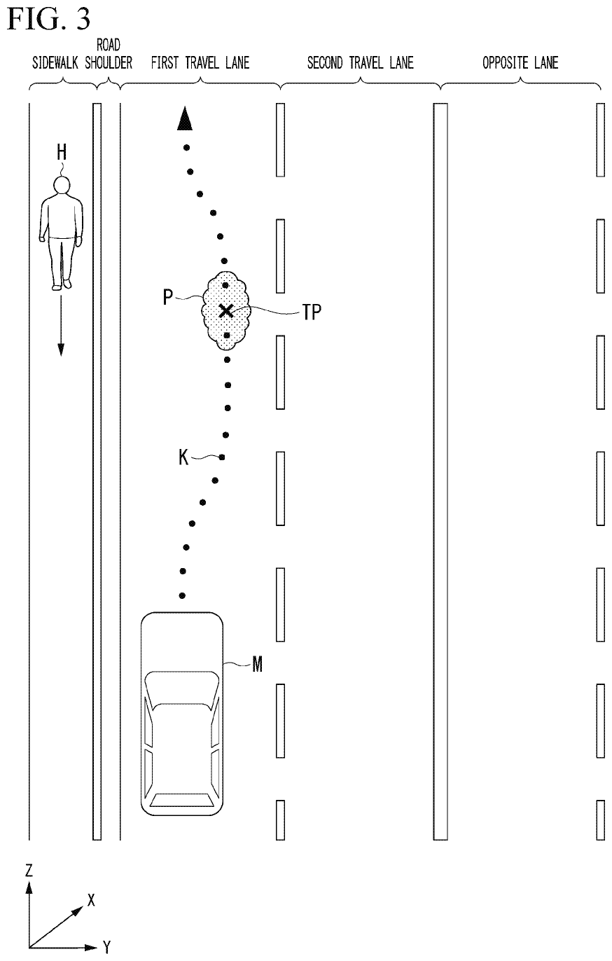

FIG. 3 is a diagram showing an example of the target trajectory in the depression-passing event according to the first embodiment. The target trajectory is a trajectory for making a change to a width direction of the road (a Y-axis direction) so that the host vehicle M which is traveling straight ahead (traveling in an X-axis direction) passes above an area occupied by the puddle. FIG. 3 shows an example in which a target trajectory for riding over the puddle P is generated if the puddle P present in front of a first travel lane has been recognized when the host vehicle M is traveling in the first travel lane of a two-lane road on one side. More specifically, the depression-passing controller 142 sets a central portion of the puddle P as a target point TP through which the host vehicle M passes and generates a target trajectory in which trajectory points K at which the host vehicle M is to arrive are sequentially arranged to form a trajectory for returning to a current traveling position after the host vehicle M passes above an area occupied by the puddle P (hereinafter, an area of the puddle P) while passing through the target point TP and riding over the puddle P. The depression-passing controller 142 generates a target trajectory along which the host vehicle M goes straight ahead from a position which is, for example, about 10 [m] before the target point TP, to the target point TP so that the host vehicle M can safely pass through the area of the puddle P.

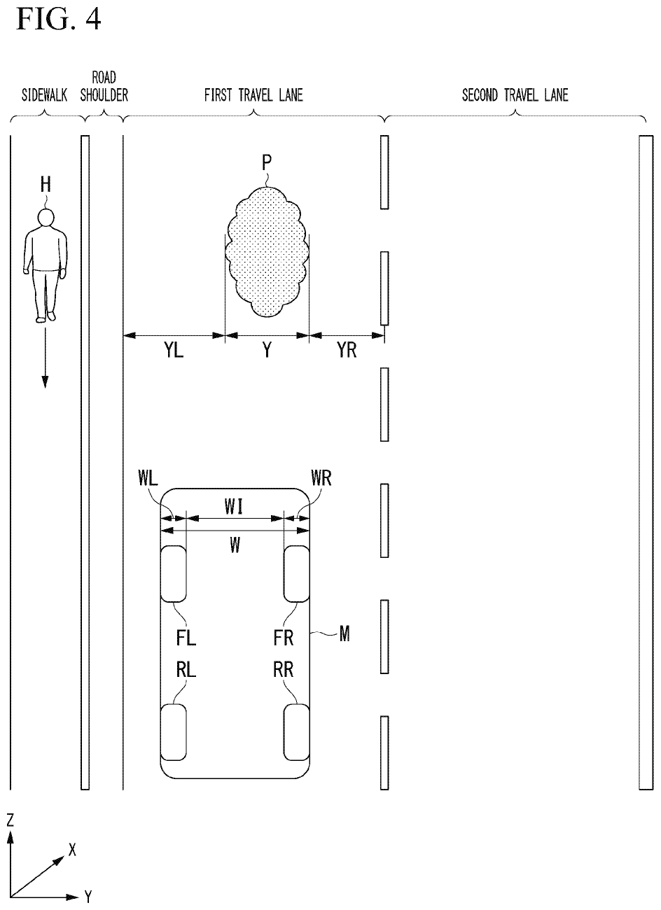

Details of the process of generating the target trajectory will be described below. FIG. 4 is a diagram showing a determination criterion of the depression-passing controller 142 according to the first embodiment. In the following description, it is assumed that a distance (a width) between two wheels in the vehicle width direction is the same at the front and rear in wheels mounted on the host vehicle M and is based on the front wheels.

The front depression recognizer 132 recognizes each of a width Y (hereinafter, a depression width Y) of the puddle in the width direction on the road, a width YL (hereinafter, a depression left width YL) from an end of a left side of the puddle P to a side end of a left side of the first travel lane (a road boundary with a road shoulder in FIG. 4), and a width YR (hereinafter, a depression right width YR) from an end of a right side of the puddle P to a side end of a right side of the first travel lane (a road boundary with a second travel lane in FIG. 4), in the puddle P. Here, the depression width Y, the depression left width YL, and the depression right width YR are, for example, widths based on a portion where the puddle P is widest in the width direction on the road. The front depression recognizer 132 may indirectly calculate the depression width Y, the depression left width YL, and the depression right width YR on the basis of a width of the first travel lane and a ratio of the puddle P to the first travel lane in the width direction.

The storage which is referred to by the depression-passing controller 142 stores a distance (a width) WI (hereinafter, an inter-wheel width WI) from a right end of a left front wheel FL of the host vehicle M to a left end of a right front wheel FR and a vehicle width W. The storage which is referred to by the depression-passing controller 142 stores a width WL (hereinafter, a left vehicle body width WL) from the right end of the left front wheel FL to the outside (an outer circumferential portion) of the vehicle body and a width WR (hereinafter, a right vehicle body width WR) from the left end of the right front wheel FR to an outer circumferential portion of the vehicle body. The vehicle width W, the left vehicle body width WL, and the right vehicle body width WR are, for example, widths including a projection mounted on the outer circumferential portion of the host vehicle M, such as a door mirror. The inter-wheel width WI, the vehicle width W, the left vehicle body width WL, and the right vehicle body width WR may be stored in a form embedded in a program. Alternatively (or additionally), the storage which is referred to by the depression-passing controller 142 may store the inter-wheel width WI based on a left rear wheel RL and a right rear wheel RR of the host vehicle M, the left vehicle body width WL, and the right vehicle body width WR.

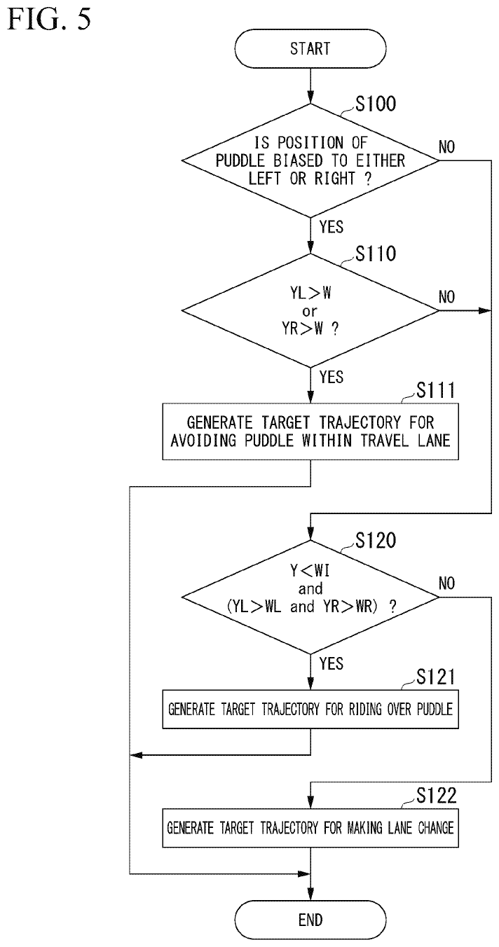

FIG. 5 is a flowchart showing an example of a flow of a process to be executed by the depression-passing controller 142 according to the first embodiment. In the following description, it is assumed that the depression-passing controller 142 has already recognized each of the depression width Y, the depression left width YL, and the depression right width YR. It is assumed that the host vehicle M is traveling in the first travel lane of two lanes on one side, the left side of the first travel lane is the road shoulder, and the right side thereof is the second travel lane.

First, the depression-passing controller 142 determines whether or not the recognized position of the puddle P is biased to either the left or the right (step S100). The fact that “the position of the puddle P is biased to either the left or the right” means that a central portion of the area of the puddle P is located at a position deviating from a central portion of a current travel lane to one side (the road shoulder side or the second travel lane side).

When it is determined that the position of the puddle P is biased to either the left or the right in step S100, the depression-passing controller 142 determines whether or not the depression left width YL exceeds the vehicle width W or whether or not the depression right width YR exceeds the vehicle width W (step S110). That is, when it is determined that the puddle P has a bias toward the road shoulder side or the second travel lane side in step S100, the depression-passing controller 142 determines whether or not it is possible to cause the host vehicle M to travel while avoiding the puddle Pin a wide area other than an area of the puddle P within the first travel lane in step S110.

When it is determined that at least one of the depression left width YL and the depression right width YR exceeds the vehicle width W in step S110, the depression-passing controller 142 generates a target trajectory for avoiding the puddle P on a side that exceeds the vehicle width W within the first travel lane (step S111) and ends the process.

On the other hand, when it is determined that the depression left width YL and the depression right width YR are less than or equal to the vehicle width Win step S110, the depression-passing controller 142 moves the process to step S120.

When it is determined that the position of the puddle P is not biased to either the left or the right in step S100 or when it is determined that the depression left width YL and the depression right width YR are less than or equal to the vehicle width W in step S110, the depression-passing controller 142 determines whether the depression width Y does not exceed the inter-wheel width WI, the depression left width YL exceeds the left vehicle body width WL, and the depression right width YR exceeds the right vehicle body width WR (step S120). That is, the depression-passing controller 142 determines whether or not the two wheels (both wheels) of the host vehicle M in the vehicle width direction can pass while riding over the puddle P without making contact therewith.

When it is determined that the depression width Y does not exceed the inter-wheel width WI, the depression left width YL exceeds the left vehicle body width WL, and the depression right width YR exceeds the right vehicle body width WR in step S120, the depression-passing controller 142 generates a target trajectory along which the host vehicle M travels while riding over the puddle P between both the wheels (step S121) and ends the process. That is, when all of the condition that the depression width Y does not exceed the inter-wheel width WI, the condition that the depression left width YL exceeds the left vehicle body width WL, and the condition that the depression right width YR exceeds the right vehicle body width WR are satisfied in step S120, the depression-passing controller 142 determines that both the wheels of the host vehicle M can pass while riding over the puddle P without making contact therewith and generates a target trajectory along which the host vehicle M travels while riding over the puddle P between both the wheels in step S121 and ends the process.

On the other hand, when the depression width Y is greater than or equal to the inter-wheel width WI, the depression left width YL is less than or equal to the left vehicle body width WL, or the depression right width YR is less than or equal to the right vehicle body width WR in step S120, the depression-passing controller 142 generates a target trajectory for making a lane change to avoid the puddle P (step S122) and ends the process. That is, when any one of the condition that the depression width Y does not exceed the inter-wheel width WI, the condition that the depression left width YL exceeds the left vehicle body width WL, and the condition that the depression right width YR exceeds the right vehicle body width WR has not been satisfied in step S120, the depression-passing controller 142 determines that both the wheels of the host vehicle M cannot pass while riding over the puddle P without making contact therewith and generates a target trajectory for making a lane change to avoid the puddle P in step S122 and ends the process.

### [First Example of Target Trajectory]

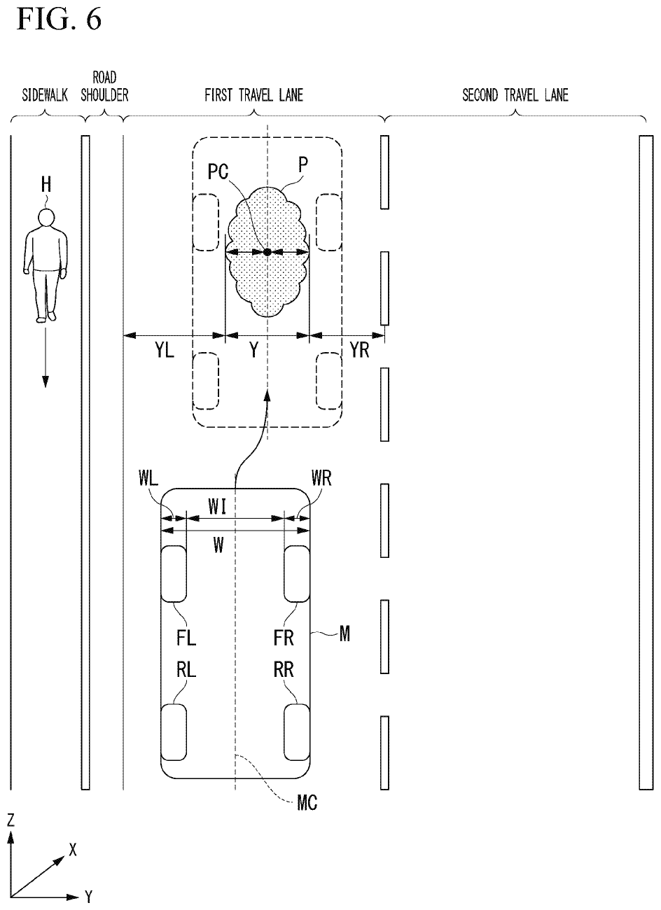

FIG. 6 is a diagram showing a first example of a target trajectory of the host vehicle M determined by the depression-passing controller 142 according to the first embodiment. FIG. 6 is a diagram showing an example of a target trajectory which is generated by the depression-passing controller 142 in step S121 and along which the host vehicle M travels while riding over the puddle P between both wheels. The depression-passing controller 142 generates a target trajectory so that a central shaft MC of the host vehicle M located at a central portion of the vehicle body passes above a central portion PC of the puddle P in the width direction on the road. The central portion PC is, for example, a center of a portion in the width direction where the puddle P is widest with respect to the width direction on the road. For example, the depression-passing controller 142 generates a target trajectory by setting the central portion PC as the target point TP, assuming that the host vehicle M travels straight ahead for a predetermined distance until the target point TP is reached, and inputting a current position and a speed vector of the host vehicle M, a position where the host vehicle M starts to travel straight ahead, and a vector in a straight-ahead direction to a model of a spline curve or the like. Thereby, the automated driving control device 100 can cause the host vehicle M to travel so that both the wheels in the vehicle width direction pass while riding over the puddle P without making contact therewith.

### [Second Example of Target Trajectory]

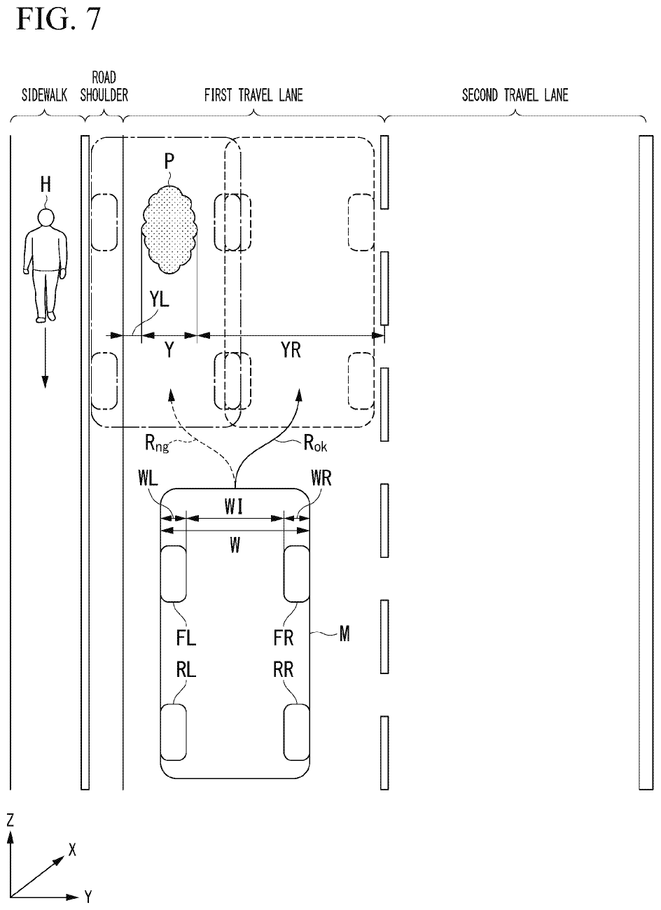

FIG. 7 is a diagram showing a second example of the target trajectory of the host vehicle M determined by the depression-passing controller 142 according to the first embodiment. FIG. 7 is a diagram showing an example of a target trajectory which is generated by the depression-passing controller 142 in step S111 and along which the host vehicle M travels while avoiding the puddle P on a side that exceeds the vehicle width W within the first travel lane. When the depression right width YR is wider than the vehicle width W, the depression-passing controller 142 generates a target trajectory of a trajectory Rₒₖ side so that the host vehicle M travels on the second travel lane side within the first travel lane to move out of the puddle P. Thereby, the automated driving control device 100 causes the host vehicle M to travel so that both the wheels in the vehicle width direction travel on the second travel lane side within the current first travel lane while moving out of the puddle P without making contact therewith. As shown for comparison in FIG. 7, when the depression-passing controller 142 generates a target trajectory of a trajectory R_{ng} side along which the host vehicle M travels while riding over the puddle P, the automated driving control device 100 causes the host vehicle M to travel while protruding toward the road shoulder side.

### [Third Example of Target Trajectory]

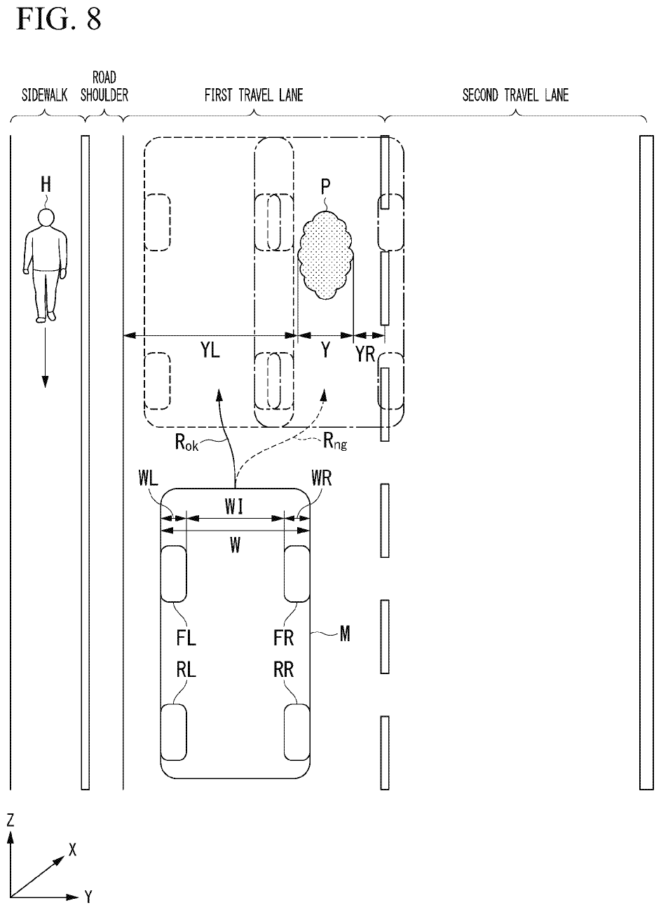

FIG. 8 is a diagram showing a third example of the target trajectory of the host vehicle M determined by the depression-passing controller 142 according to the first embodiment. FIG. 8 is a diagram showing an example of another target trajectory which is generated by the depression-passing controller 142 in step S111 and along which the host vehicle M travels while avoiding the puddle P on a side that exceeds the vehicle width W within the first travel lane. When the depression left width YL is wider than the vehicle width W, the depression-passing controller 142 generates a target trajectory of a trajectory Rₒₖ side so that the host vehicle M travels on the road shoulder side within the first travel lane to move out of the puddle P. Thereby, the automated driving control device 100 can cause the host vehicle M to travel so that both the wheels in the vehicle width direction travel while moving out of the puddle P on the road shoulder side in a direction opposite to that of the second example of the target trajectory shown in FIG. 7 within the current first travel lane without making contact therewith. As shown for comparison in FIG. 8, when the depression-passing controller 142 generates a target trajectory of a trajectory R_{ng} side along which the host vehicle M travels while riding over the puddle P, the automated driving control device 100 causes the host vehicle M to travel while protruding toward the second lane side.

As described above, according to the depression-passing controller 142 of the first embodiment, it is possible to generate a target trajectory for avoiding (riding over or moving out of) the puddle P within the first travel lane in which the host vehicle M is currently traveling on the basis of a relationship of widths in the host vehicle M and widths in the puddle P. Thereby, in the automated driving control device 100 according to the first embodiment, when a depression such as the puddle P is present in the current travel lane in which the host vehicle M is traveling, it is also possible to more smoothly control the traveling of the host vehicle M without making a lane change for avoiding the puddle P, i.e., without performing ineffective control (driving control) for avoiding the puddle P.

In step S111, the target trajectory generated by the depression-passing controller 142 may have a different amount of movement out of the puddle P within the first travel lane. For example, the target trajectory of the trajectory Rₒₖ side shown in FIG. 7 may be a target trajectory further away from the puddle P than the target trajectory of the trajectory Rₒₖ side shown in FIG. 8. That is, when the puddle P is present on the road shoulder side, the traveling of the host vehicle M may be controlled so that the host vehicle M is further away from the puddle P than when the puddle P is present on the second travel lane side. In this case, when the host vehicle M passes through a position where the puddle P is present, it is possible to reduce a possibility that, for example, a pedestrian H or the like who is walking on the sidewalk will be splashed with water. Further, in this case, the depression-passing controller 142 may generate a target trajectory for reducing (decelerating) the speed when the host vehicle M passes through a position where the puddle P is present. Thereby, it is possible to further reduce the possibility of splashing to the pedestrian H or the like, which may be caused when the host vehicle M passes through the position where the puddle P is present. For example, if the adjacent lane is an opposite lane, the depression-passing controller 142 may generate a target trajectory for causing the host vehicle M to decelerate also when the host vehicle M is predicted to pass an opposite vehicle when passing through the position where the puddle P is present. In this case, when the host vehicle M passes through the position where the puddle P is present, for example, it is possible to reduce the possibility that the driver of the opposite vehicle will feel endangered.

### Second Embodiment

Hereinafter, a second embodiment will be described. In the second embodiment, when a target trajectory for making a lane change in the first embodiment is generated, the target trajectory is generated on the basis of a policy in which two wheels (both wheels) of a host vehicle M in a vehicle width direction do not have to pass over a puddle P (a depression) present on a travel lane in which the host vehicle M is traveling without making contact therewith. In an automated driving control device 100 of the second embodiment, a front depression recognizer 132 further recognizes a deepest position Dₘₐₓ (hereinafter, a deepest portion Dₘₐₓ) in the depression and the depression-passing controller 142 generates a target trajectory along which a center of the host vehicle M passes above the deepest portion Dₘₐₓ. In the following description, as in the first embodiment, the puddle P will be described as an example of the depression. The front depression recognizer 132 can recognize the depth of the puddle (the depression) on the basis of, for example, an image analysis result of the camera 10 and a result of detecting a distance from the radar device 12 and the finder 14.

As described below, the depression-passing controller 142 of the second embodiment generates a target trajectory including a trajectory along which a central shaft MC passes above the deepest portion Dₘₐₓ of the puddle P, i.e., a trajectory along which one or both of two wheels of the host vehicle M in a vehicle width direction pass through an area of a part of the puddle P. The fact that “the central shaft MC passes above the deepest portion Dₘₐₓ of the puddle P” means that at least a part of an area of a vehicle body between the two wheels of the host vehicle M in the vehicle width direction passes above an area occupied by the puddle and corresponds to a meaning that the host vehicle M rides over the puddle as in the first embodiment.

Also, in the second embodiment, a depression-passing event based on the front depression recognizer 132 and the depression-passing controller 142 is similar to that of the first embodiment. Accordingly, description of the depression-passing event in the second embodiment will be omitted.

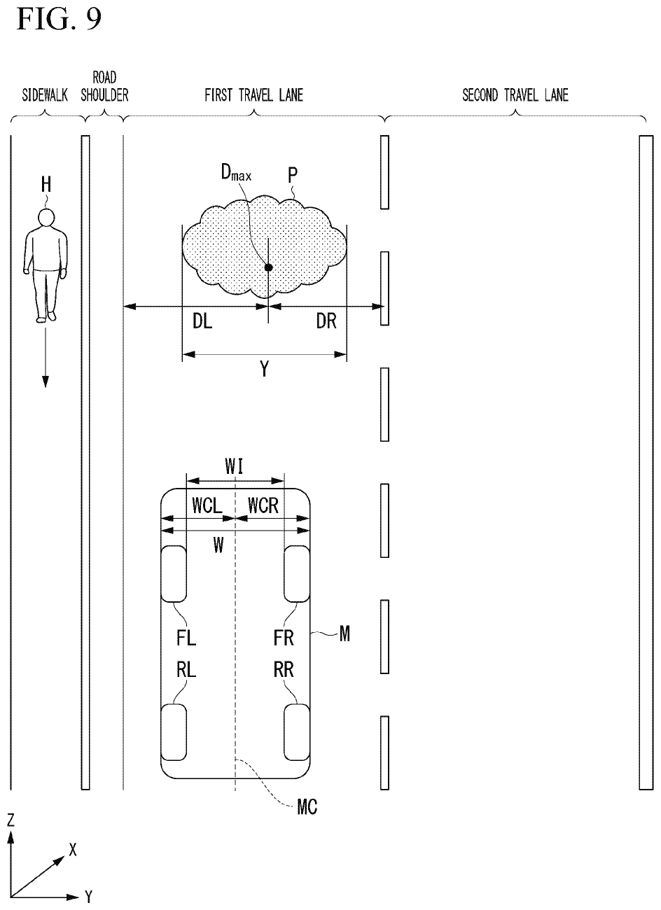

Details of a more detailed process of generating the target trajectory will be described below. FIG. 9 is a diagram showing a determination criterion of the depression-passing controller 142 according to the second embodiment. Also, in the following description, as in the first embodiment, it is assumed that an inter-wheel width WI of wheels mounted on the host vehicle M is the same at the front and rear and is based on an inter-wheel width WI of the front wheels.

The front depression recognizer 132 further recognizes each of a width DL (hereinafter referred to as a depression center left width DL) from the deepest portion Dₘₐₓ of the puddle P to a side end of a left side of a first travel lane (a road boundary with a road shoulder in FIG. 9) and a width DR (hereinafter referred to as a depression center right width DR) from the deepest portion Dₘₐₓ of the puddle P to a side end of a right side of the first travel lane (a road boundary with a second travel lane in FIG. 9), in the puddle P. As in the first embodiment, the front depression recognizer 132 may indirectly calculate the depression center left width DL and the depression center right width DR on the basis of a width of the first travel lane and a ratio of the puddle P to the first travel lane in the width direction.

The storage which is referred to by the depression-passing controller 142 further stores a width WCL (hereinafter, a central left vehicle body width WCL) from the central shaft MC of the host vehicle M to an outer circumferential portion of a right end of the vehicle body and a width WCR (hereinafter, a central right vehicle body width WCR) from the central shaft MC to an outer circumferential portion of a left end of the vehicle body. The central left vehicle body width WCL and the central right vehicle body width WCR are, for example, widths including a projection mounted on the host vehicle M, such as a door mirror, as in the first embodiment.

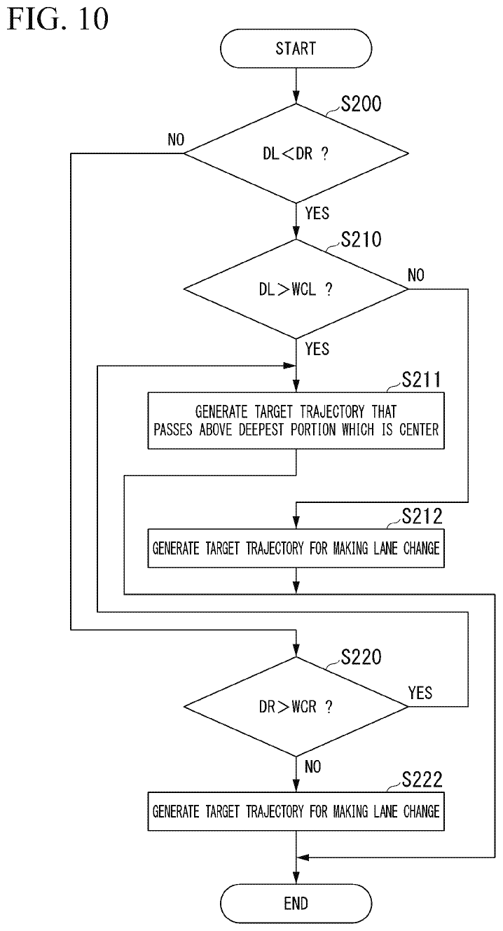

FIG. 10 is a flowchart showing an example of a flow of a process to be executed by the depression-passing controller 142 according to the second embodiment. Also, in the following description, it is assumed that the widths of the depression in the puddle P including the depression width Y, the depression center left width DL, and the depression center right width DR (and further including the depression left width YL and the depression right width YR) are already recognized in the depression-passing controller 142. As in the first embodiment, it is assumed that the host vehicle M is traveling in the first travel lane of two lanes on one side, the left side of the first travel lane is the road shoulder, and the right side thereof is the second travel lane.

The depression-passing controller 142 according to the second embodiment executes the following process instead of step S122 in the process of the first embodiment shown in FIG. 5.

First, the depression-passing controller 142 determines whether or not the depression center left width DL is less than the depression center right width DR (step S200). That is, the depression-passing controller 142 determines whether the position of the deepest portion Dₘₐₓ of the puddle P in the width direction on the first travel lane is on the road shoulder side or on the second travel lane (adjacent lane) side.

When it is determined that the depression center left width DL is less than the depression center right width DR in step S200, the depression-passing controller 142 determines whether or not the depression center left width DL exceeds the central left vehicle body width WCL (step S210). That is, when the depression-passing controller 142 determines whether or not the host vehicle M protrudes toward the road shoulder side when a target trajectory along which the central shaft MC passes above the deepest portion Dₘₐₓ of the puddle P on the left side (the road shoulder side) of the first travel lane has been generated. In other words, the depression-passing controller 142 determines whether or not it is possible to generate a target trajectory along which one or both of the two wheels of the host vehicle M in the vehicle width direction pass through a partial area of the puddle P at a position on the road shoulder side.

When it is determined that the depression center left width DL exceeds the central left vehicle body width WCL in step S210, the depression-passing controller 142 generates a target trajectory along which the central shaft MC passes above the deepest portion Dₘₐₓ and travels in the area of the puddle P (step S211) and ends the process.

On the other hand, if it is determined that the depression center left width DL is less than or equal to the central left vehicle body width WCL in step S210, the depression-passing controller 142 generates a target trajectory for making a lane change to avoid the puddle P (step S212) and ends the process.

On the other hand, when it is determined that the depression center left width DL is greater than or equal to the depression center right width DR in step S200, the depression-passing controller 142 determines whether or not the depression center right width DR exceeds the central right vehicle body width WCR (step S220). That is, when a target trajectory along which the central shaft MC passes above the deepest portion Dₘₐₓ of the puddle P on the right side (the second travel lane side) of the first travel lane has been generated, the depression-passing controller 142 determines whether or not the host vehicle M protrudes toward the second travel lane side. In other words, the depression-passing controller 142 determines whether or not it is possible to generate a target trajectory along which one or both of the two wheels of the host vehicle M in the vehicle width direction pass through a partial area of the puddle P at a position on the second travel lane side.

When it is determined that the depression center right width DR exceeds the central right vehicle body width WCR in step S220, the depression-passing controller 142 generates a target trajectory along which the central shaft MC passes above the deepest portion Dₘₐₓ and travels in the area of the puddle Pin step S211 and ends the process.

On the other hand, when it is determined that the depression center right width DR is less than or equal to the central right vehicle body width WCR in step S220, the depression-passing controller 142 generates a target trajectory for making a lane change to avoid the puddle P (step S222) and ends the process.

### [Fourth Example of Target Trajectory]

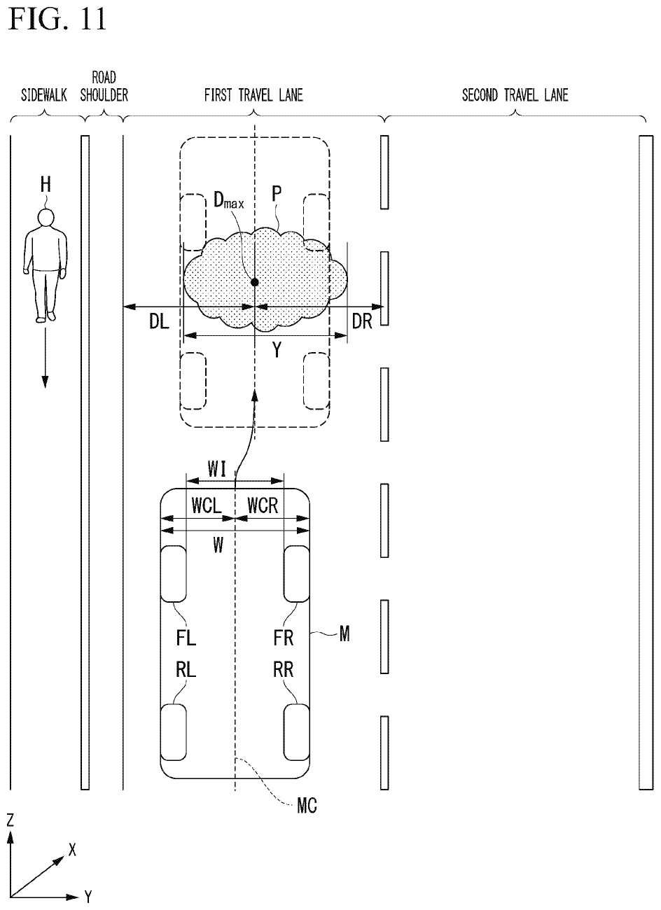

FIG. 11 is a diagram showing a fourth example of the target trajectory of the host vehicle M determined by the depression-passing controller 142 according to the second embodiment. FIG. 11 is a diagram showing an example of a target trajectory which is generated by the depression-passing controller 142 in step S211 and along which the central shaft MC passes above the deepest portion Dₘₐₓ and travels in the area of the puddle P. When the depression center left width DL exceeds the central left vehicle body width WCL or the depression center right width DR exceeds the central right vehicle body width WCR, the depression-passing controller 142 generates a target trajectory so that the central shaft MC in the host vehicle M passes above the deepest portion Dₘₐₓ in the puddle P. For example, the depression-passing controller 142 generates a target trajectory with the deepest portion Dₘₐₓ as the target point TP. Thereby, the automated driving control device 100 can cause the host vehicle M to travel so that, although one or both of the two wheels of the host vehicle M in the vehicle width direction pass through a partial area of the puddle P, the host vehicle M passes through the puddle P within a current travel lane (here, within the first travel lane).

As described above, according to the depression-passing controller 142 according to the second embodiment, it is possible to generate a target trajectory along which the host vehicle M passes through a partial area of the puddle P within the first travel lane in which the host vehicle M is currently traveling on the basis of a relationship of the widths in the host vehicle M, the widths in the puddle P, and the deepest portion Dₘₐₓ. Thereby, in the automated driving control device 100 according to the second embodiment, it is possible to more smoothly control the traveling of the host vehicle M without making a lane change to avoid the puddle P, i.e., without performing ineffective control (driving control) for avoiding the puddle P, also when a depression such as a puddle P having a width (a depression width Y) wider than the vehicle width W is present on the current travel lane of the host vehicle M.

In step S211, the target trajectory generated by the depression-passing controller 142 may be a target trajectory for reducing (decelerating) the speed when the host vehicle M passes through the position where the puddle P is present. Thereby, when one or both of the two wheels of the host vehicle M in the vehicle width direction pass through a partial area of the puddle P, for example, it is possible to reduce a possibility that an influence on the steering wheel (i.e., an influence on steering control) will be exerted due to a step of the puddle P (the depression) or the resistance of pooled water. Further, in this case, when the host vehicle M passes through the position where the puddle P is present, it is also possible to reduce for example, a possibility that the pedestrian H or the like who is walking on the sidewalk will be splashed with water, and, for example, a possibility that a driver of an opposite vehicle which passes the host vehicle M will feel endangered.

Also, in the first embodiment, the depression-passing controller 142 may generate a target trajectory that passes above the deepest portion Dₘₐₓ in the puddle P as shown in FIG. 11. That is, the target trajectory may be generated so that the central portion PC shown in FIG. 6 is the deepest portion Dₘₐₓ. In this case, in step S120 in the example of the flow of the process to be executed by the depression-passing controller 142 shown in FIG. 5, the depression-passing controller 142 may perform a process using a width less than the inter-wheel width WI (for example, a width of inter-wheel width WI×0.8) instead of the inter-wheel width WI.

### Third Embodiment

Hereinafter, a third embodiment will be described. In the third embodiment, when a target trajectory for making a lane change in the first embodiment is generated, a target trajectory along which a host vehicle M can travel in a state in which two wheels (both wheels) of the host vehicle M in a vehicle width direction are not in contact with a puddle P (a depression) is generated also when a central shaft MC does not necessarily pass above a deepest portion Dₘₐₓ of the puddle P (the depression) present on a travel lane in which the host vehicle M is traveling as in the second embodiment. In the automated driving control device 100 according to the third embodiment, a front depression recognizer 132 further recognizes a three-dimensional structure of the depression, and a depression-passing controller 142 generates a target trajectory along which the host vehicle M passes through a side where a rate of change in a height related to the depression in a vehicle width direction is gentle. In the following description, as in the first embodiment, the puddle P will be described as an example of the depression. For example, the front depression recognizer 132 recognizes the three-dimensional structure in the puddle (the depression), i.e., a change in the puddle (the depression) in a depth direction, on the basis of, for example, an image analysis result of the camera 10 and a result of detecting a distance from the radar device 12 and the finder 14. Thereby, the front depression recognizer 132 can recognize a rate of change in a height of an area of the puddle (the depression).

As described below, the depression-passing controller 142 according to the third embodiment generates a target trajectory including a trajectory along which one or both of two wheels of the host vehicle M in the vehicle width direction pass through a side where the rate of change in the height of the host vehicle M in the vehicle width direction in the area of the puddle P is gentle. The fact that “the rate of change in the height of the host vehicle M in the vehicle width direction in the area of the puddle P is gentle” means that a difference between the height of the actual road surface and the height (depth) at each position within the area of the puddle P is less than or equal to an amount that can be estimated not to have a significant influence on the traveling of the host vehicle M, i.e., that there are few steps at each position in the area of the puddle P. Then, the term “passing through the side where the rate of change in the height of the host vehicle M in the vehicle width direction in the area of the puddle P is gentle” means that at least a part of an area of a vehicle body between the two wheels of the host vehicle M in the vehicle width direction passes above an area occupied by the puddle and corresponds to a meaning that the host vehicle M rides over the puddle as in the first embodiment and the second embodiment.

Also, in the third embodiment, a depression-passing event based on the front depression recognizer 132 and the depression-passing controller 142 is similar to that of the first embodiment. Accordingly, description of the depression-passing event in the third embodiment will be omitted.

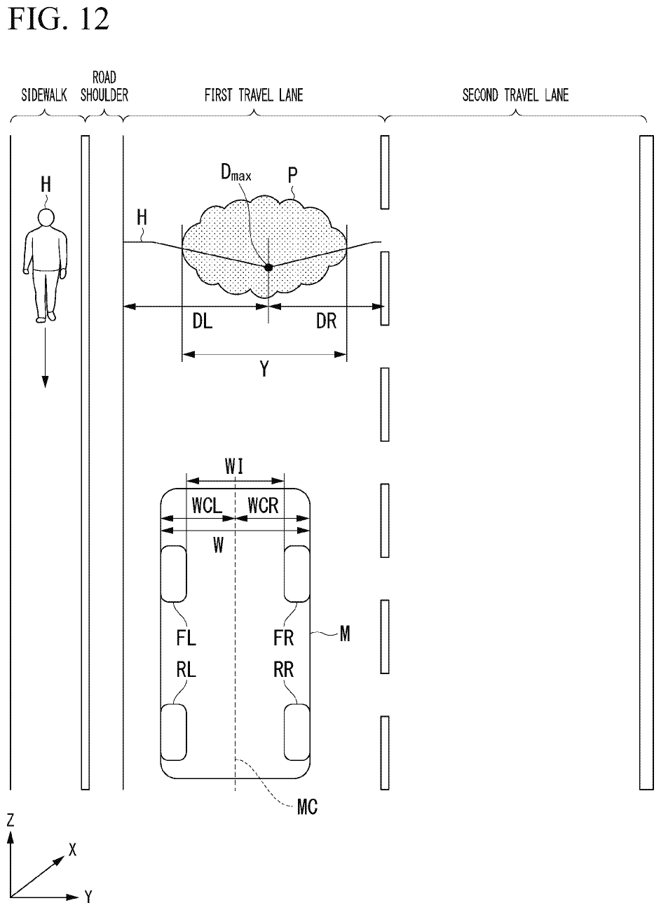

Details of a more detailed process of generating the target trajectory will be described below. FIG. 12 is a diagram showing a determination criterion of the depression-passing controller 142 according to the third embodiment. Also, in the following description, as in the first embodiment and the second embodiment, it is assumed that an inter-wheel width WI of wheels mounted on the host vehicle M is the same at the front and rear and is based on an inter-wheel width WI of the front wheels.

The front depression recognizer 132 further recognizes the rate of change in the height of the area of the puddle P in the puddle P. FIG. 12 shows a change in a height H of a road surface (hereinafter, a road surface height H) in the vehicle width direction of the host vehicle M in a first travel lane as an example for recognizing a rate of change in a height of an area of the puddle P. The front depression recognizer 132 recognizes a difference (a step) between a road surface height H in an area other than the puddle P and a road surface height H at each position in the area of the puddle P as a rate of change in the height of the area of the puddle P. As in the first and second embodiments, the front depression recognizer 132 may recognize a rate of change in the height of the area of the puddle P by indirectly calculating an actual road surface height H on the basis of a width of the first travel lane and a ratio of the puddle P to the first travel lane in a width direction as in the first embodiment and the second embodiment.

The depression-passing controller 142 sets the side of the area of the puddle P in which the rate of change in the height of the road surface height H is less than or equal to a predetermined threshold value as the side on which the rate of change is gentle and generates a target trajectory along which at least one wheel passes through the area of the puddle P.

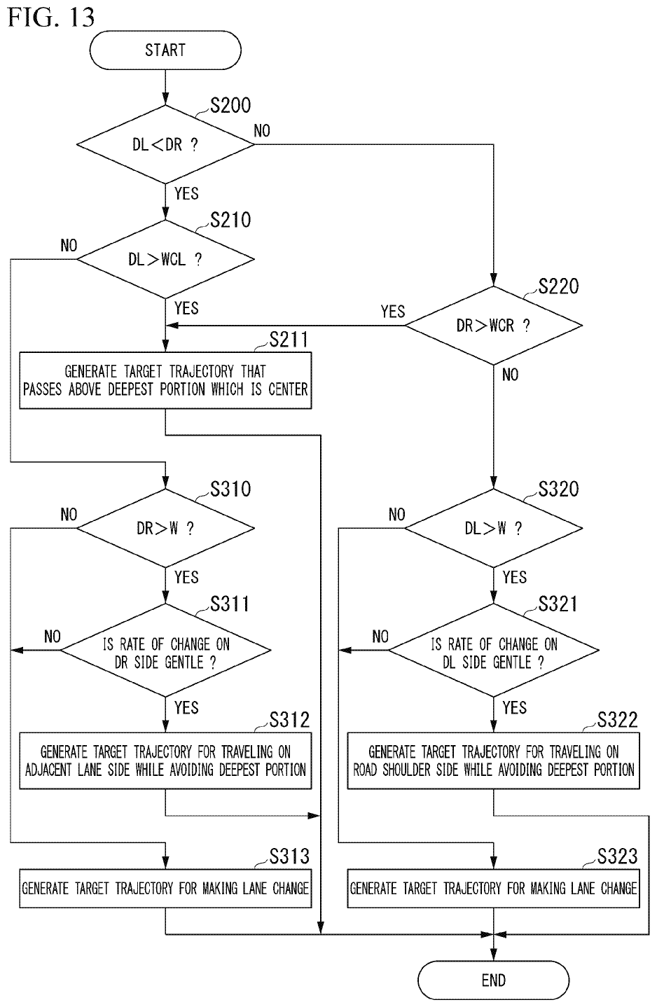

FIG. 13 is a flowchart showing an example of a flow of a process to be executed by the depression-passing controller 142 according to the third embodiment. FIG. 13 shows a flowchart of a process to be executed by the depression-passing controller 142 in the third embodiment in addition to the process to be executed by the depression-passing controller 142 in the second embodiment shown in FIG. 10. Accordingly, in the following description, description of a process similar to the second embodiment will be omitted. Also, in the following description, in the depression-passing controller 142, it is assumed that the widths of the depression in the puddle P including the depression width Y, the depression center left width DL, and the depression center right width DR (and further including the depression left width YL and the depression right width YR) and the side where the rate of change in the height in the vehicle width direction in the area of the puddle P is gentle have already been recognized. As in the first and second embodiments, it is assumed that the host vehicle M is traveling in the first travel lane of two lanes on one side, the left side of the first travel lane is the road shoulder, and the right side thereof is the second travel lane.

The depression-passing controller 142 according to the third embodiment executes the following process instead of step S122 in the process of the first embodiment shown in FIG. 5.

First, when it is determined that the depression center left width DL is less than or equal to the central left vehicle body width WCL in the processing of step S210, the depression-passing controller 142 determines whether or not the depression center right width DR exceeds the vehicle width W (step S310). That is, when a target trajectory for avoiding the deepest portion Dₘₐₓ of the puddle P on the left side has been generated, the depression-passing controller 142 determines whether or not the host vehicle M protrudes toward the second travel lane side. In other words, when a target trajectory along which at least left wheels (a left front wheel FL and a left rear wheel RL) pass through a partial area on the right side of the puddle P has been generated, the depression-passing controller 142 determines whether or not the host vehicle M protrudes toward the second travel lane side.

When it is determined that the depression center right width DR is less than or equal to the vehicle width W in step S310, the depression-passing controller 142 generates a target trajectory for making a lane change to avoid the puddle P (step S313) and ends the process.

On the other hand, when it is determined that the depression center right width DR exceeds the vehicle width W in step S310, the depression-passing controller 142 determines whether or not the rate of change on the depression center right width DR side, i.e., the rate of change in the area on the right side of the puddle P, is gentle (step S311).

When it is determined that the rate of change on the depression center right width DR side is not gentle in step S311, the depression-passing controller 142 generates a target trajectory for making a lane change to avoid the puddle P in step S313 and ends the process.

On the other hand, when it is determined that the rate of change on the depression center right width DR side is gentle in step S311, the depression-passing controller 142 generates a target trajectory that passes through a partial area of the right side of the puddle P while avoiding the deepest portion Dₘₐₓ on the left side within the first travel lane (step S312) and ends the process.

On the other hand, when the depression-passing controller 142 determines that the depression center right width DR is less than or equal to the central right vehicle body width WCR in the processing of step S220, the depression-passing controller 142 determines whether or not the depression center left width DL exceeds the vehicle width W (step S320). That is, when a target trajectory for avoiding the deepest portion Dₘₐₓ of the puddle P on the right side has been generated, the depression-passing controller 142 determines whether or not the host vehicle M protrudes toward the road shoulder side. In other words, when the target trajectory along which at least right wheels (a right front wheel FR and a right rear wheel RR) pass through a partial area on the left side of the puddle P has been generated, the depression-passing controller 142 determines whether or not the host vehicle M protrudes toward the road shoulder side.

When it is determined that the depression center left width DL is less than or equal to the vehicle width W in step S320, the depression-passing controller 142 generates a target trajectory for making a lane change to avoid the puddle P (step S323) and ends the process.

On the other hand, when it is determined that the depression center left width DL exceeds the vehicle width W in step S320, the depression-passing controller 142 determines whether or not the rate of change on the depression center left width DL side, i.e., the rate of change in the left area of the puddle P, is gentle (step S321).

When it is determined that the rate of change on the side of the depression center left width DL is not gentle in step S321, the depression-passing controller 142 generates a target trajectory for making a lane change to avoid the puddle P in step S323 and ends the process.

On the other hand, when it is determined that the rate of change on the depression center left width DL side is gentle in step S321, the depression-passing controller 142 generates a target trajectory that passes through a partial area of the left side of the puddle P while avoiding the deepest portion Dₘₐₓ on the right side within the first travel lane (step S322) and ends the process.

### [Fifth Example of Target Trajectory]

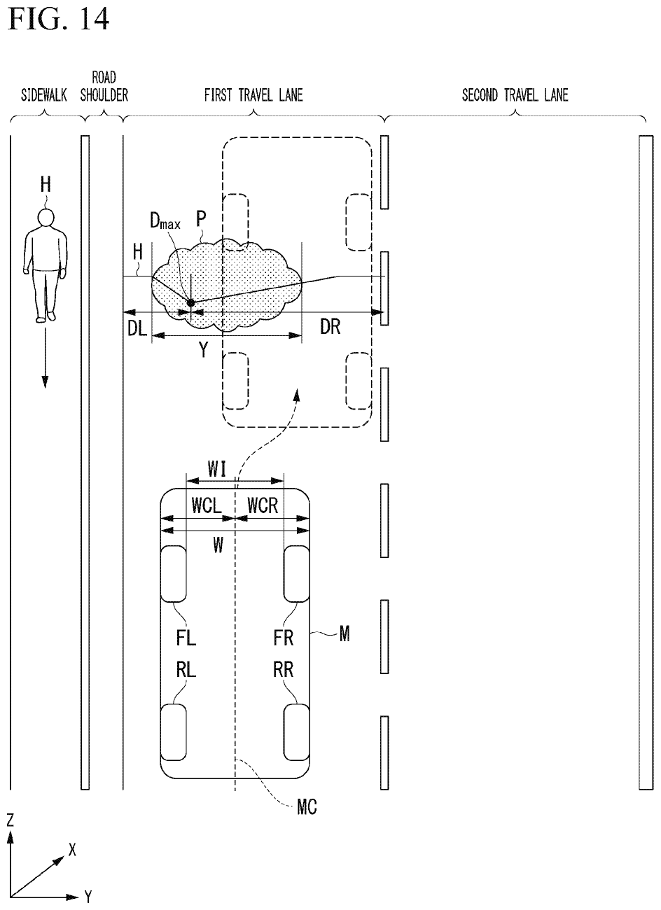

FIG. 14 is a diagram showing a fifth example of the target trajectory of the host vehicle M determined by the depression-passing controller 142 according to the third embodiment. FIG. 14 is a diagram showing an example of a target trajectory which is generated by the depression-passing controller 142 in step S312 and which passes through a partial area of the right side of the puddle P while avoiding the deepest portion Dₘₐₓ on the right side within the first travel lane. When the depression center right width DR exceeds the vehicle width W, the depression-passing controller 142 generates a target trajectory so that, although the host vehicle M passes through a partial area on the right side of the puddle P while traveling on the second travel lane side within the first travel lane, the host vehicle M travels while avoiding the deepest portion Dₘₐₓ on the right side. Thereby, the automated driving control device 100 can cause the host vehicle M to travel so that, although at least one of the four wheels of the host vehicle M in the vehicle length direction (here, the left front wheel FL and the left rear wheel RL) passes through a partial area of the puddle P, the host vehicle M passes through the puddle P within the current travel lane (here, within the first travel lane).

It is possible to easily understand a case in which the depression-passing controller 142 generates a target trajectory that passes through the partial area on the left side of the puddle P while avoiding the deepest portion Dₘₐₓ on the left side within the first travel lane in step S322 from the fifth example of the target trajectory shown in FIG. 14. Accordingly, in this case, a description of a relationship of the widths in the host vehicle M and the widths in the puddle P will be omitted.

As described above, according to the depression-passing controller 142 according to the third embodiment, it is possible to generate a target trajectory that passes through a partial area of the puddle P within the first travel lane in which the host vehicle M is currently traveling on the basis of a relationship of the widths in the host vehicle M, the widths in the puddles P, and the road surface height H. Thereby, in the automated driving control device 100 according to the third embodiment, it is possible to more smoothly control traveling of the host vehicle M without making a lane change to avoid the puddle P, i.e., without performing ineffective control (driving control) for avoiding the puddle P, also when a depression such as a puddle P having a width (a depression width Y) wider than the vehicle width W is present on the current travel lane of the host vehicle M.

In steps S312 and S322, the target trajectory generated by the depression-passing controller 142 may be a target trajectory for reducing (decelerating) the speed when the host vehicle M passes through the position where the puddle P is present. Thereby, when at least one of the four wheels of the host vehicle M in the vehicle length direction passes through a partial area of the puddle P, for example, it is possible to reduce a possibility that the influence on the steering wheel (i.e., an influence on steering control) will be exerted due to a step of the puddle P (the depression) or the resistance of pooled water. Further, if the depression-passing controller 142 generates the target trajectory in step S312, when the host vehicle M passes through the position where the puddle P is present, it is also possible to reduce, for example, a possibility that the pedestrian H or the like who is walking on the sidewalk will be splashed with water, and, for example, a possibility that a driver of an opposite vehicle which passes the host vehicle M will feel endangered.

### [Hardware Configuration]

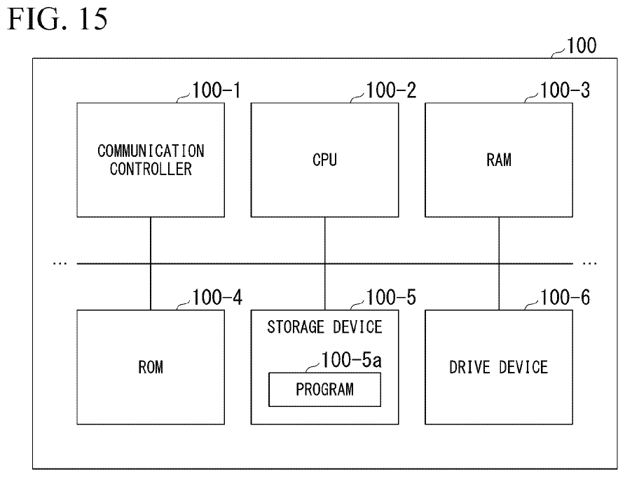

FIG. 15 is a diagram showing an example of a hardware configuration of the automated driving control device 100 of the embodiment. As shown in FIG. 15, the automated driving control device 100 has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or a hard disk drive (HDD), a drive device 100-6, and the like are mutually connected by an internal bus or a dedicated communication line. The communication controller 100-1 communicates with components other than the automated driving control device 100. The storage device 100-5 stores a program 100-5a to be executed by the CPU 100-2. This program is loaded to the RAM 100-3 by a direct memory access (DMA) controller (not shown) or the like and executed by the CPU 100-2. Thereby, one or both of the first controller 120 and the second controller 160, specifically, the front depression recognizer 132 and the depression-passing controller 142, are implemented.

The embodiment described above can be represented as follows.

A vehicle control device including:

a storage device storing a program; and

a hardware processor,

wherein the hardware processor executes the program stored in the storage device to:

recognize a surrounding environment of a vehicle;

perform driving control according to speed control and steering control of the vehicle on the basis of a recognition result;

recognize a depression present on a road where the vehicle travels; and

cause the vehicle to travel while riding over the depression in a case where a width of the depression is less than or equal to a predetermined width.

In the above-described embodiment, a case in which a target trajectory for riding over the puddle P as an example of the depression is generated has been described. However, for example, the depression may include various forms other than the puddle, such as depressions within the travel lane. In this case, the traveling control of the host vehicle M by the automated driving control device 100 can be easily understood from the description of the above-described embodiment. Accordingly, a description of a case in which the depression has a form other than the puddle is omitted.

In the embodiment described above, the length of the puddle P in the traveling direction of the host vehicle M, i.e., the width of the depression in the depth direction of the road, is not recognized. However, the automated driving control device 100 may be configured to further recognize the width of the depression in the depth direction by means of the front depression recognizer 132 and cause the host vehicle M to travel as described in the embodiment. In this case, the depression-passing controller 142 may be configured to generate the target trajectory for avoiding the depression in the current travel lane as described in the embodiment when the width of the depression in the depth direction is less than or equal to a predetermined width threshold value and generate a target trajectory for avoiding the depression by making a lane change when the width of the depression in the depth direction is greater than the predetermined width threshold value.

Although modes for carrying out the present invention have been described using embodiments, the present invention is not limited to the embodiments, and various modifications and substitutions can also be made without departing from the scope and spirit of the present invention.

What is claimed is:

1. A vehicle control device comprising:
a recognizer configured to recognize a surrounding environment of a vehicle; and
a driving controller configured to perform driving control according to speed control and steering control of the vehicle on the basis of a recognition result of the recognizer,
wherein the recognizer is configured to recognize a depression on a road where the vehicle travels, and
wherein the driving controller is configured to cause the vehicle to travel while riding over the depression in a case where a width of the depression is less than or equal to a predetermined width.

2. The vehicle control device according to claim 1,
wherein the driving controller is configured to cause the vehicle to travel under a condition that a central portion of the vehicle in a vehicle width direction passes above a central portion of the depression in the vehicle width direction.

3. The vehicle control device according to claim 1,
wherein the recognizer is configured to recognize a deepest portion in the depression, and
wherein the driving controller is configured to cause the vehicle to travel under a condition that a central portion of the vehicle in a vehicle width direction passes above the deepest portion.

4. The vehicle control device according to claim 1,
wherein the recognizer is configured to recognize a three-dimensional structure of the depression, and
wherein the driving controller is configured to cause the vehicle to travel under a condition that the vehicle is biased toward a side where a rate of change in a height related to the depression in a vehicle width direction is gentle in a case where the driving controller is unable to cause the vehicle to travel under a condition that both wheels of the vehicle are not in contact with the depression.

5. The vehicle control device according to claim 1,
wherein the driving controller is configured to cause the vehicle to travel on a side away from the one end side in a case where the depression has a bias toward one end side of the road in a width direction.

6. The vehicle control device according to claim 1,
wherein the driving controller is configured to cause the vehicle to travel while being biased in a direction in which an area other than an area of the depression is wider in a width direction of the road in a case where the depression is separated from both ends of the road and the vehicle is unable to travel under a condition that both wheels of the vehicle are not in contact with the depression.

7. The vehicle control device according to claim 6,
wherein the driving controller is configured to cause the vehicle to travel on a side away from the adjacent lane in a case where the depression has a bias toward an adjacent lane side and at least a part of a vehicle width of the vehicle is brought into an adjacent lane if the driving controller is configured to cause the vehicle to travel under a condition that both wheels of the vehicle are not in contact with the depression.

8. The vehicle control device according to claim 6,
wherein the driving controller is configured to cause the vehicle to travel on a side away from the road shoulder in a case where the depression has a bias toward a road shoulder side of the road and at least a part of a vehicle width of the vehicle exceeds a road shoulder if the driving controller is configured to cause the vehicle to travel under a condition that both wheels of the vehicle are not in contact with the depression.

9. The vehicle control device according to claim 8,
wherein the driving controller is configured to cause the vehicle to travel on a side further away from a road shoulder than when the depression has a bias toward an adjacent lane side in a case where the depression has a bias toward the road shoulder side of the road.

10. The vehicle control device according to claim 5,
wherein the driving controller is configured to cause the vehicle to travel at a reduced speed in a case where the depression has a bias toward a road shoulder side of the road.

11. A vehicle control method using a computer comprising:
recognizing a surrounding environment of a vehicle;
performing driving control according to speed control and steering control of the vehicle on the basis of a recognition result;
recognizing a depression on a road where the vehicle travels; and
causing the vehicle to travel while riding over the depression in a case where a width of the depression is less than or equal to a predetermined width.

12. A computer-readable non-transitory storage medium storing a program for causing a computer of a vehicle control device to:
recognize a surrounding environment of a vehicle;
perform driving control according to speed control and steering control of the vehicle on the basis of a recognition result;
recognize a depression on a road where the vehicle travels; and
cause the vehicle to travel while riding over the depression in a case where a width of the depression is less than or equal to a predetermined width.
